(19) United States
(12) Patent Application Publication
(10) Pub. No.: US 2007/0291760 A1
(43) Pub. Date: Dec. 20, 2007

(54) Apparatus and Method For Dualizing an Asynchronous Transfer Mode (Atm) Router in a Cdma2000 System

(75) Inventor: Tae Hong Kim, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited, Kyongki-do (KR)

(21) Appl. No.: 10/585,602

(22) PCT Filed: Jan. 14, 2005
(86) PCT No.: PCT/KR05/00134

§ 371 Date: Jun. 20, 2007

(30) Foreign Application Priority Data
Jan. 15, 2004 (KR) 10-2004-0002973

(51) Int. Cl. H04L 12/28

(52) U.S. Cl. 370/395.1

(57) ABSTRACT

The present invention provides an apparatus and method for dualizing an Asynchronous Transfer Mode (ATM) router in a CDMA2000 system. In a conventional wireless communication system, an ATM router in a Base Station Controller (BSC) has two separate dualized main central processing boards, which are also referred to as ADSL Subscriber Physical board Assembly (ASPA) boards. Each of the ASPA boards includes one operation and maintenance processor, which maintains configuration and operation information. One of the conventional dualized ASPA boards transmits its configuration and operation information to the other, or receives the information from the other, in the form of message. This is in order to maintain the consistency between the information of the dualized ASPA boards, as needed. Such message passing, however, is generally time consuming and may possibly create network overload. According to the invention, the dualized ASPA boards communicate the configuration and operation information with each other using a File Transfer Protocol (FTP), rather than by message passing. Accordingly, communicating the information takes relatively less time, which can considerably reduce the whole system loads and decrease the possibility of data inconsistency between the dualized ASPA boards.

### TECHNICAL FIELD

The present invention generally relates to an apparatus and method for dualizing an Asynchronous Transfer Mode (ATM) router in a CDMA2000 system, and more particularly to an apparatus and method for maintaining consistency between configuration and operation information stored in dualized ADSL Subscriber Physical board Assembly (ASPA) boards, which are incorporated in the ATM router within a base station controller (BSC).

### BACKGROUND ART

In a conventional wireless communication system, an ATM router within a BSC has dualized its main central processing unit boards (hereinafter, referred to as “ASPA boards”). This is to ensure the stability of the whole system by harmonizing the information between the dualized ASPA boards. Each ASPA board has an operation and maintenance processor (hereinafter, referred to as “SCMB”). When the ASPA is initially driven, the SCMB within the ASPA board generally receives information messages such as configuration or operation information from an ATM Card and a Switch Card managed by the ASPA. This is in order to build data associated with the respective cards. If an operational state is changed or some error occurs during the operation, the ASPA modifies these data.

With the conventional dualization technique, if the two ASPA boards are not initiated simultaneously during start-up, then each of the ASPA boards may receive and maintain different information messages from the ATM or Switch Card, especially when the operation state of any of the cards is changed during the interval between the initiations. This may result in some problems in maintaining the dualized structure. In order to eliminate such data discrepancy, the two SCMBs in the ASPA boards communicate messages with each other. However, this may cause operational overload in the ASPA boards, as well as another discrepancy due to the state change during the communication.

### DISCLOSURE OF THE INVENTION

It is, therefore, an object of the present invention to provide an apparatus and method for maintaining consistency between dualized ASPA boards within an ATM router in a CDMA system. This is accomplished by communicating configuration and operation information using a file transfer protocol (FTP) instead of a message-passing scheme.

In accordance with one aspect of the invention, there is provided an apparatus for dualizing an Asynchronous Transfer Mode (ATM) router in a CDMA2000 system, the apparatus comprising: a first ADSL Subscriber Physical board Assembly (ASPA) board; a second ASPA board, wherein each of the two ASPA boards comprises a disk-on-chip for storing configuration and operation information; a memory for storing an executable format of an object associated with the configuration and operation information; a dualized processor for transmitting and receiving the configuration and operation information using File Transfer Protocol (FTP); and a operation and maintenance processor for storing the configuration and operation information in the disk-on-chip and generating an object executable on the memory from the information stored in the disk-on-chip.

In accordance with another aspect of the invention, there is provided a method for dualizing an ATM router in a CDMA2000 system, the method comprising the steps of: at a dualized processor, determining in which of three states an ASPA board is, wherein the three states are Single, Active and Standby, respectively; if it is determined that the ASPA board is in the Single or Active state, at the dualized processor, initiating an operation and maintenance processor; at the operation and maintenance processor, receiving messages from managed cards, generating an configuration and operation information therefrom and storing the configuration and operation information in a disk-on-chip; and at the operation and maintenance processor, generating an object executable on a memory from the configuration and operation information and notifying the other ASPA board of the object generation when generating the object is completed, or if it is determined that the ASPA board is in the Standby state, at the dualized processor, waiting until receiving the notification of the generation is completed; at the dualized processor, upon receiving the notification, receiving the configuration and operation information stored in the disk-on-chip of the other ASPA board using a FTP, and storing the information in a disk-on-chip of the ASPA board where the dualized processor is mounted; at the dualized processor, initiating an operation and maintenance processor; and at the operation and maintenance processor, generating an object executable on a memory from the configuration and operation information.

### BRIEF DESCRIPTION OF DRAWINGS

FIG. 1 is a structural diagram illustrating a dualization configuration of an ATM router in a conventional wireless communication system.

FIG. 2 is a structural diagram illustrating a dualization configuration of an ATM router in a CDMA2000 system according to an embodiment of the present invention.

FIG. 3 is a flow chart of a method for dualizing an ATM router in CDMA2000 system according to an embodiment of the present invention.

### BEST MODE FOR CARRYING OUT THE INVENTION

In the disclosure below, a preferred embodiment of the present invention will be described in detail with reference to the accompanying drawings.

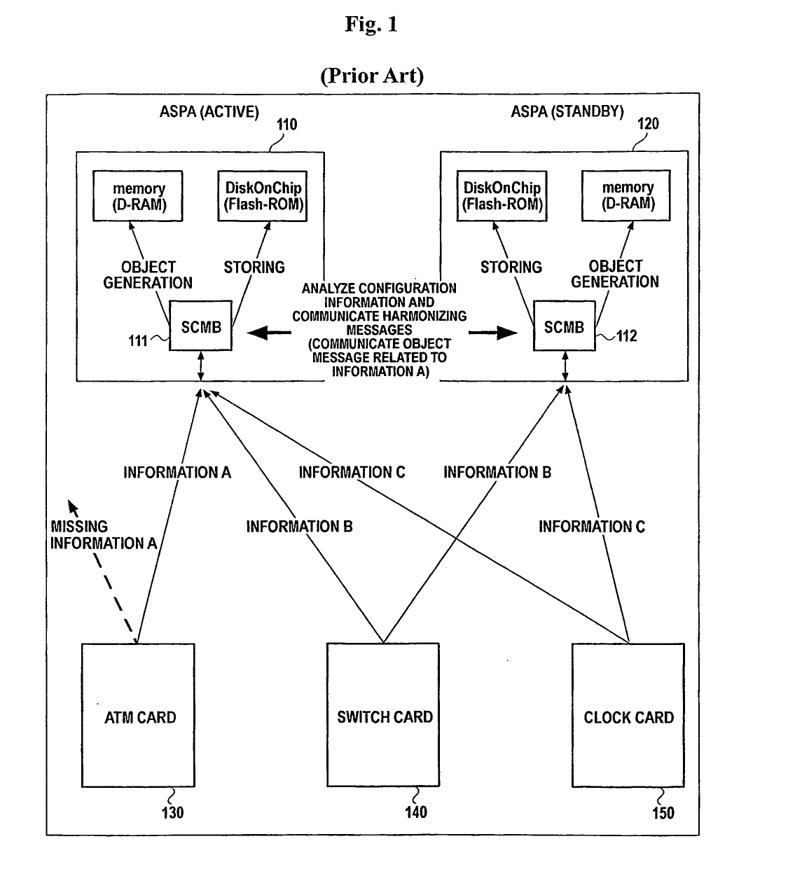

FIG. 1 is a structural diagram illustrating a dualization configuration of an ATM router in a conventional wireless communication system. A first ASPA 110 and a second ASPA 120 receive information messages from ATM Card 130, Switch Card 140 and Clock Card 150 respectively to build data associated with the cards. A first SCMB 111 and a second SCMB 112 communicate their own configuration and operation information in the form of message with each other to maintain the dualization structure by harmonizing the information.

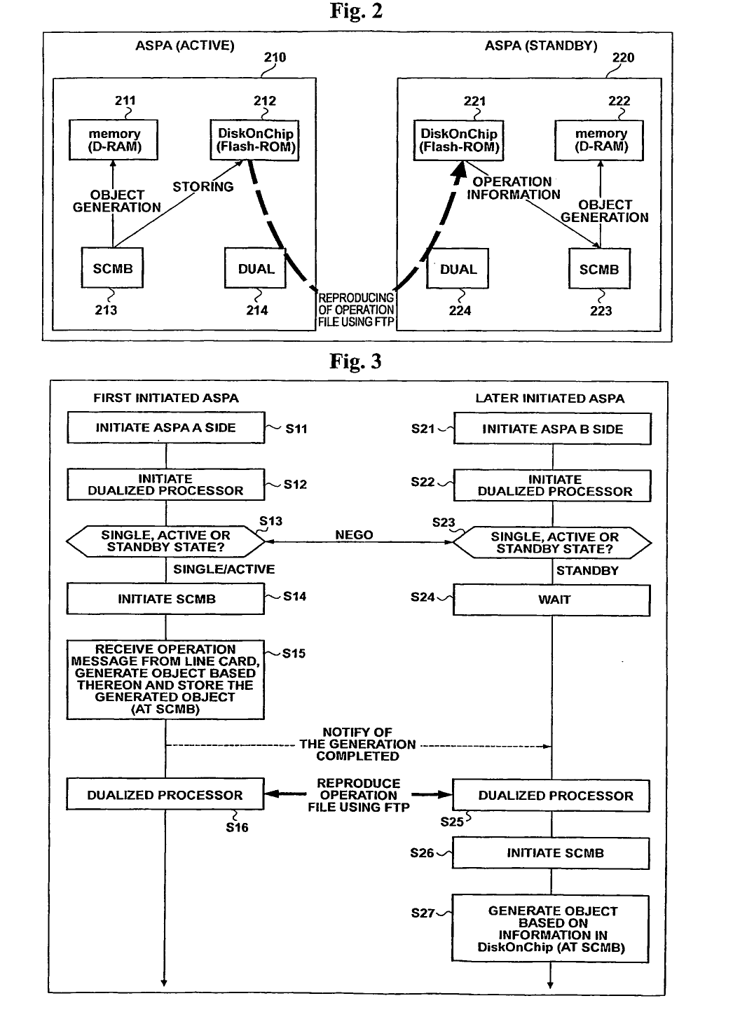

FIG. 2 is a structural diagram illustrating a dualization configuration of an ATM router in a CDMA2000 system in accordance with one embodiment of the present invention. In the ATM router within the dualized wireless communication system, an ASPA board has one of three states: Single, Active and Standby. The Single state indicates that the only one of the two ASPA boards has been powered up. When both of the two ASPA boards are powered up, a running board of the two ASPA boards has the Active state and the other board on standby has the Standby state. Each ASPA board includes memories 211 and 221, disk-on-chips 212 and 222, SCMBs 213 and 223, and dualized processors 214 and 224. Disk-on-chips 212 and 222 are non-volatile memories (e.g., flash ROM) for storing the configuration and operation information of the respective ASPA boards. Dualized processors 214 and 224 are in charge of dualizing the ASPA boards. More specifically, in order to maintain the consistency between the information of the dualized boards, a dualized processor embedded in a ASPA board, which is either first powered up or first used as an Active board when the two boards are powered up simultaneously, transmits at one time the configuration and operation information stored on the disk-on-chip to the dualized processor within the other ASPA board using a file transfer protocol (FTP). Then, the receiving processor reproduces the received information into the disk-on-chip and marks the information update with a global variable. Compared with a message-passing scheme, communicating the information at one time using the FTP is much less time-consuming and thus can considerably reduce the whole system loads. If the global variable indicates that the information has been received and stored into the disk-on-chip using the FTP, SCMB 213 or 223, which is operation and maintenance processor for managing and updating the configuration and operation information in the ASPA board, generates an object in the memory based on the configuration and operation information reproduced at the disk-on-chip. Otherwise, SCMB 213 or 223 builds the configuration and operation information based on the received message from the managed card such as the ATM Card, the Switch Card and the Clock Card, as described below.

FIG. 3 is a flow chart of a method for dualizing an ATM router in CDMA2000 system according to an embodiment of the present invention. When an ASPA is powered up into operation, a plurality of processors within the ASPA are generated and executed sequentially on a priority basis, i.e., a previously generated processor generates another processor with the next priority. First, in blocks S11 and S22, the dualized processors are initially initiated. In blocks S13 and S23, the dualized processor determines in which of the three states the ASPA board remains, the three states being Single, Active and Standby, respectively. If the ASPA board is in the Single state indicating that only one of the two ASPA boards is initiated, there is no valid operation information on the disk-on-chip within the other ASPA. Thus, the ASPA board puts the SCMB into operation (block S14) and directs it to receive and store the internal information from the managed cards, such as the ATM Card, the Switch Card, the Clock Card, at the disk-on-chip to generate an executable object on the memory from the information (block S15). Similarly, if the ASPA board is in the Active state, i.e., the ASPA board is to be first used of the two dualized boards powered up simultaneously, then the ASPA board puts the SCMB into operation (block S14) and generates an object on the memory from the operation message received from the managed cards (block S15). On the other hand, if the ASPA board is in the Standby state, it waits until the other ASPA board in the Active or Single state generates the configuration and operation information (block S24). When the object is completely generated (block S15), the Active or Single ASPA issues a notification of the object generation to the Standby ASPA board. Upon receiving the notification, the dualized processor within the standby ASPA board receives the generated configuration and operation information from the disk-on-chip within the Active or Single ASPA board using the FTP (block S25). The ASPA board in the Single or Active state employs a FTP server to transmit the configuration and operation information stored at its disk-on-chip by the FTP. The dualized processor in the Standby ASPA board, when receiving the configuration and operation information, writes the information in the disk-on-chip and then initiates the SCMB after updating the relevant global variable to indicate that the received configuration and informational information by the FTP has been written in the disk-on-chip (block S26). In block S27, if the global variable indicates that the received configuration and operation information by the FTP has been written in the disk-on-chip, the SCMB reads the information in the disk-on-chip during the start-up to generate the object associated with the information on the memory (block S27).

With the dualized ASPA boards working, if one of the ASPA boards is unmounted or shut down due to some operational errors such as an interruption of the power supply and a short circuit, the other board gets into the Single state. Further, if the stalled ASPA board gets restarted, the ASPA board iu the Single state gets into the Active and the restarted ASPA board into the Standby state. In other words, when the state of the working ASPA boards is changed, a dualized processor within the Standby ASPA board receives the configuration and operation information from the Active ASPA board using the FTP to generate the object, as it does during start-up.

### INDUSTRIAL APPLICABILITY

As described above, according to the present invention, the dualized ASPA boards communicate the configuration and operation information with each other using the FTP instead of a message-passing scheme. This can considerably reduce the system loads and decrease the possibility of data inconsistency between the dualized ASPA boards. As such, the time needed to harmonize the configuration and operation information can be shortened in inverse proportion to the file transmission rate. Furthermore, when the configuration and operation information needs to be extended, only the data structure thereof has to be modified without additional messages communicated, which may facilitate the maintenance of the whole system.

1. An apparatus for dualizing an Asynchronous Transfer Mode (ATM) router in a CDMA2000 system, the apparatus comprising:
a first ADSL Subscriber Physical board Assembly (ASPA) board; and
a second ASPA board;
wherein the first ASPA board comprises a first disk-on-chip for storing configuration and operation information; a first memory for storing an executable format of an object associated with the configuration and operation information; a first dualized processor for transmitting the configuration and operation information to the second ASPA board or receiving the configuration and operation information form the second ASPA board using File Transfer Protocol (FTP); and a first operation and maintenance processor for storing the configuration and operation information in the first disk-on-chip and generating an object executable on the memory fi-om the information stored in the first disk-on-chip,
and wherein the second ASPA board comprises a second disk-on-chip for storing configuration and operation information; a second memory for storing an executable format of an object associated with the configuration and operation information; a second dualized processor for transmitting the configuration and operation information to the first ASPA board or receiving the configuration and operation information from the first ASPA board using the FTP; and a second operation and maintenance processor for storing the configuration and operation information in the second disk-on-chip and generating an object executable on the memory from the information stored in the second disk-on-chip.

2. A method for dualizing an ATM router in a CDMA2000 system, the method comprising the steps of:
at a dualized processor, determining in which of three states an ASPA board is, wherein the three states are Single, Active and Standby;
if it is determined that the ASPA board is in the Single or Active state,
at the dualized processor, initiating an operation and maintenance processor;
at the operation and maintenance processor, receiving messages from managed cards, generating an configuration and operation information therefrom and storing the configuration and operation information in a disk-on-chip; and
at the operation and maintenance processor, generating an object executable on a memory from the configuration and operation information and notifying the other ASPA board of the object generation when generating the object is completed,
or if it is determined that the ASPA board is in the Standby state,
the dualized processor, waiting until receiving the notification of the generation completed;
at the dualized processor, upon receiving the notification, receiving the configuration and operation information stored in the disk-on-chip of the other ASPA board using a FTP, and storing the information in a disk-on-chip of the ASPA board where the dualized processor is mounted;
at the dualized processor, initiating an operation and maintenance processor; and
at the operation and maintenance processor, generating an object executable on a memory from the configuration and operation information.
